(19) United States
(12) Patent Application Publication
(10) Pub. No.: US 2006/0047690 A1
(43) Pub. Date: Mar. 2, 2006

(54) Integration of Flex and Yacc into a linguistic services platform for named entity recognition

(75) Inventors: Kevin W. Humphreys, Redmond, WA (US); Hisakazu Igarashi, Bellevue, WA (US); Kevin R. Powell, Kirkland, WA (US)

Correspondence Address: WESTMAN CHAMPLIN (MICROSOFT CORPORATION), SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/939,300

(22) Filed: Sep. 10, 2004

Related U.S. Application Data
(63) Continuation-in-part of application No. 10/930,131, filed on Aug. 31, 2004.

(51) Int. Cl. G06F 17/00

(52) U.S. Cl. 707/102

(57) ABSTRACT

Method of integrating Flex and Yacc (or their respective equivalents) into a named entity recognition engine used as a component of a general text processing system is provided. The named entity recognition engine adds results into a central representation or lattice for use by various subsequent applications. The applications can configure which named entity classes or types are recognized via an application program interface. The text processing system configures input and output through the lattice for Flex and Yacc to maintain high performance. Optionally, the text processing system minimizes expensive lexicon look-up by maximizing named entity constituents matched by Flex-generated recognizers.

The present application is a continuation in part of and claims priority of U.S. patent application Ser. No. ______, filed Aug. 31, 2004, (attorney docket no. M61.12-0700) the content of which is hereby incorporated by reference in its entirety.

### BACKGROUND OF THE INVENTION

The present invention relates to natural language processing. More specifically, the present invention relates to integrating machine compiler tools, Flex and Yacc, or their respective equivalents, into a linguistic services platform for named entity recognition.

Named entities are terms in natural language text or speech identifying individual concepts by name, such as person or company names. Broadly, named entities can also include temporal expressions such as date or time expressions, locations, which can include virtual locations such as email and web addresses, and quantity expressions such as digits, number words, monetary values, percentages and the like. Generally, named entity terms cannot be reliably identified by simple matching against stored lists or lexicons because such lists of all known names would be impractically large to maintain. Also, novel names are continually being created.

Named entity terms, however, do have internal linguistic structure, which can be described by relatively simple grammatical or linguistic rules. These simple grammatical rules can be used to recognize or identify name entities by parsing natural language text. However, the expense of analyzing text with a full natural language parser usually means that the computational cost of named entity recognition is too high to be considered in any application where performance is an important consideration.

An improved method of recognizing, identifying or extracting named entities in natural language text, especially integrated into a larger natural language processing system, that addresses one, some or all of the problems would have significant utility.

### SUMMARY OF THE INVENTION

The present inventions relate to integrating named entity recognition that relies on machine or computer compiler tools such as Flex and Yacc (or their respective equivalents) into a larger natural language processing system or linguistic services platform that can be accessed through an application programming interface (API). A compiler tool commonly referred to as a lexical analyzer (scanner) generator, e.g. Flex or Lex or an equivalent tool, is used to identify named entities (e.g. digits, date and time expressions, and email or web addresses) using regular expression rules. Another compiler tool commonly referred to as a parser generator, e.g. Yacc or Bison or an equivalent tool, is used to identify named entities (e.g. person and company names) using grammar rules. In most embodiments, the lexical analyzer generator is used in combination with the parser generator to identify named entities in natural language text. In some embodiments, multiple lexical analyzers and/or parsers identify one or more classes of named entities, such as email addresses or person names, which can be used to produce an annotated version of the text. Identified named entities or annotated text are then returned through the API.

### BRIEF DESCRIPTION OF THE DRAWINGS

FIG. 1 illustrates one illustrative environment in which the present invention can be used.

FIG. 2 illustrates a natural language processing system with named entity recognition capability in accordance with the present inventions.

FIG. 3A illustrates a lexical analyzer generator processing regular expression rules to generate a finite-state lexical analyzer.

FIG. 3B illustrates a parser generator processing grammar rules to generate a finite-state parser.

FIG. 4 illustrates using a finite state recognizer to process natural language text.

FIG. 5A illustrates a Flex-generated lexical analyzer processing natural language text.

FIG. 5B illustrates a Yacc-generated parser processing natural language text.

FIG. 6 illustrates a lexical analyzer and parser, in combination, processing natural language text.

FIG. 6A illustrates output generated by the system illustrated in FIG. 6 received by a full lexical parser.

FIG. 7 illustrates a named entity recognition system in accordance with the present inventions.

FIG. 8 illustrates a method of identifying named entities in accordance with the present inventions.

### DETAILED DESCRIPTION OF ILLUSTRATIVE EMBODIMENTS

The present invention relates to identifying or extracting named entities in natural language text processing. As used herein, the term “named entity” includes numbers, date and time expressions, email addresses, web addresses, currencies, and other regular expressions. “Named entity” further includes names such as person, company, location, country, state, city, and the like. In one aspect, a standard machine compiler comprising compiler tools such as Flex and/or Yacc is used for named entity recognition, and in one particular aspect, to construct or update at least one index including named entities. However, prior to discussing the present invention in greater detail, one illustrative environment in which the present invention can be used will be described.

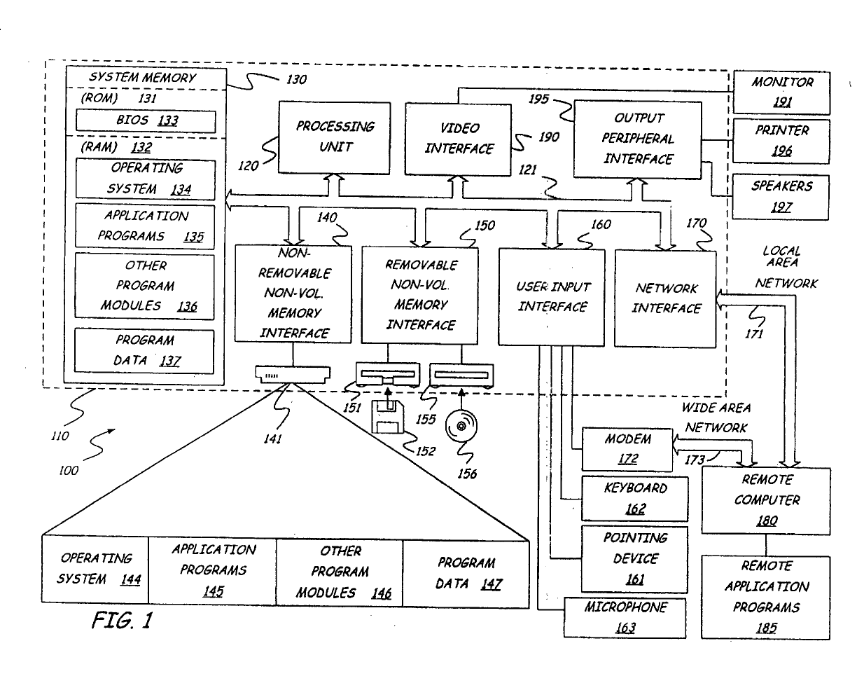

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephone systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Those skilled in the art can implement the description and figures provided herein as processor executable instructions, which can be written on any form of a computer readable medium.

The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

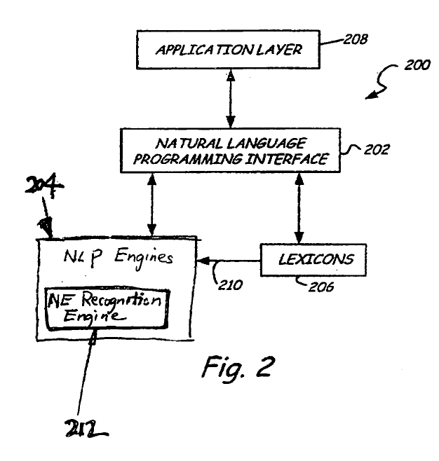

FIG. 2 is a block diagram illustrating a natural language processing system with named entity recognition capability. A general environment similar to FIG. 2 has been described in detail in U.S. patent application Ser. No. 10/813,652 filed on Mar. 30, 2004, which is hereby incorporated by reference in its entirety.

Natural language processing system 200 includes natural language programming interface 202, natural language processing (NLP) engines 204 including named entity (NE) recognition engine 212, and associated lexicons 206. FIG. 2 also illustrates that system 200 interacts with an application layer 208 that includes application programs. Such application programs can be natural language processing applications, which require access to natural language processing services that can be referred to as a Linguistic Services Platform or “LSP”.

Programming interface 202 exposes elements (methods, properties and interfaces) that can be invoked by application layer 208. The elements of programming interface 202 are supported by an underlying object model (further details of which are provided in the above incorporated patent application) such that an application in application layer 208 can invoke the exposed elements to obtain natural language processing services.

In order to do so, an application in layer 208 can first access the object model that exposes interface 202 to configure interface 202. The term “configure” is meant to include selecting desired natural language processing features or functions. For instance, the application may wish to have word breaking or language auto detection performed as well as any of a wide variety of other features or functions. Those features can be elected in configuring interface 202 as well. In another instance, the application can include named entity recognition where interface 202 is configured to recognize selected types of named entities such as email addresses or person names and disregard other types.

Once interface 202 is configured, application layer 208 may provide text, such as natural language text received from the Internet or other sources, to be processed to interface 202. Interface 202, in turn, can break the text into smaller pieces and access one or more natural language processing engines 204 to perform natural language processing (e.g. named entity recognition) on the input text. The results of the natural language processing performed can, for example, be provided back to the application in application layer 208 through programming interface 202 or used to update lexicons 206 (discussed below).

Interface 202 or NLP engines 204 can also utilize lexicons 206. Lexicons 206 can be updateable or fixed. System 200 can provide a core lexicon 206 so additional lexicons are not needed. However, interface 202 also exposes elements that allow applications to add customized lexicons 206. For example, if the application is directed to an Internet search engine or web crawler, a customized named entity lexicon having, e.g. person and/or company names can be added or accessed. Of course, other lexicons can be added as well.

In some embodiments, NE recognition engine 212 takes advantage of lexicons 206 by using them to classify words or tokens into types of named entities or constituents for use in general linguistic rules described in greater detail below, e.g. person first names and city names, so that NE recognition engine 212 does not need to have a fixed set built into its rules, and lexicons 206 do not need to include full names which can be recognized by rules.

In addition, interface 202 can expose elements that allow applications to add notations to the lexicon so that when results are returned from a lexicon, the notations are provided as well, for example, as properties of the result.

Generally, compiler tools such as Flex, Lex, Yacc, or Bison are designed for the analysis of programming languages, and thus, have a limited ability to analyze patterns and/or expressions in text. However, compiler tools have been optimized over the years so that their performance is highly tuned to maximize the efficiency of their analyses.

Many named entities represent well-constrained subsets of full natural language structures. It has been discovered that many named entities generally have structures or patterns that can be described or specified in terms that allow limited programming languages and compiler tools to be used, even though their limitations are much too restrictive for general natural language processing or analysis.

In particular, it has been discovered that simple rules such as Forename+Surname (e.g. John Smith) or Ordinal+Month+Digits (e.g. 29 Feb. 2004) can be expressed within the formalism of programming language tools, and applied to input text very efficiently. Additionally, actions, processes, or steps can be associated with rules, which can be used to construct normalized representations of certain named entity categories or classes such as person names or time and date expressions. The normalized representations facilitate subsequent searching of text for particular information by abstracting away from the way in which the information was expressed in a particular text. For example, the expressions 29 Feb. 2004 and Feb. 29, 2004 can be assigned equivalent representations.

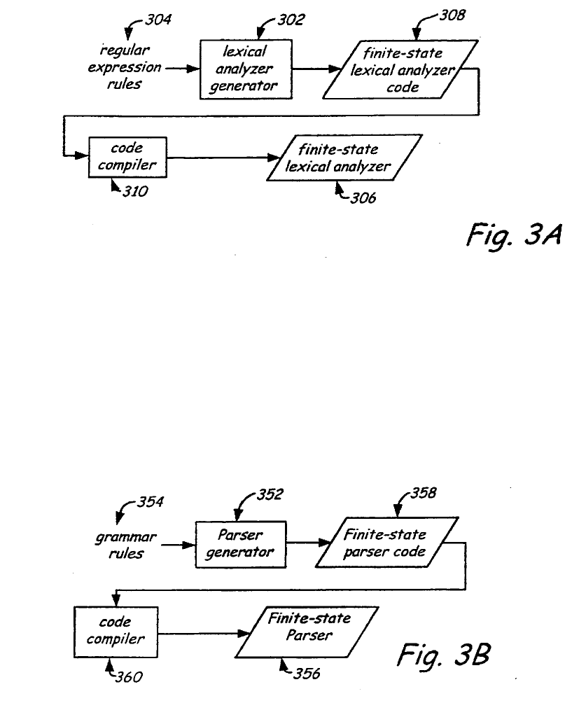

FIGS. 3A and 3B illustrate various compiler tools (e.g. a lexical analyzer generator in FIG. 3A and a parser generator in FIG. 3B) being used in natural language processing. FIG. 3A illustrates lexical analyzer generator 302 receiving and/or processing regular expression rules 304 to generate finite-state analyzer 306 dedicated to regular expression rules 304. Lexical analyzer generator 302 converts regular expression rules 304 into finite-state lexical analyzer code or representations 308. Code compiler 310 receives and/or processes finite-state lexical analyzer code 308 to produce or generate an executable program implemented as finite-state lexical analyzer 306. Code compiler 310 can be a standard compiler used for any computer language such as Fortran, Basic, C, and C++. However, in many embodiments code compiler 310 can be a standard C/C++, C#, or similar compiler. Regular expression rules 304 comprise character rules.

FIG. 3B illustrates parser generator 352 receiving and/or processing linguistic or grammar rules 354 to generate finite-state parser 356 dedicated to grammar rules 354. Parser generator 352 converts grammar rules 354 to finite-state parser code or representations 358. Code compiler 360 compiles parser code 358 into an executable program implemented as finite-state parser 356. Grammar rules 354 comprise token rules.

In the present inventions, character and/or token rules are advantageous because they can be authored by linguists for a particular natural language, such as English, German, or Chinese. Rules 304, 354 are implemented to identify or specify patterns in natural language text associated with named entities in the particular natural language of interest. Rules 304, 354 can comprise one or more sets of rules, each of which is associated with a particular class or category of named entity, such as email address, location name, person name, or date expression. Rules 304, 354 can also be broken up to create a cascade of recognizers (lexical analyzers or parsers), each of which is associated with one or more classes of named entities.

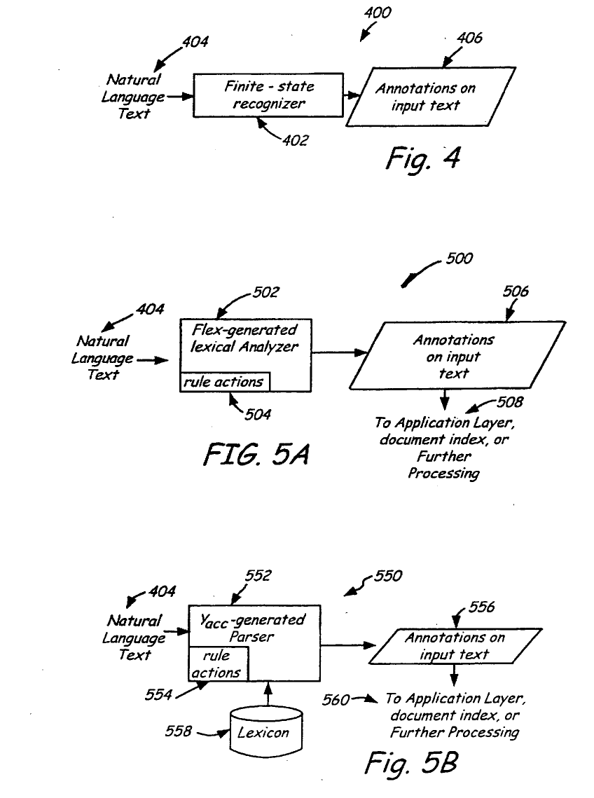

FIG. 4 illustrates system 400, which performs named entity recognition or identification in natural language text. System 400 comprises finite-state recognizer 402 generated by methods illustrated in FIG. 3A and/or FIG. 3B. It is noted that both lexical analyzers and parsers are types of recognizers. In the present inventions, such recognizers can be implemented as finite-state machines for high performance. Finite-state recognizer 402 generates annotations 406 on input text in accordance with rules similar to rules 304, 354 in FIGS. 3A and 3B, respectively. Annotations 406 can include information such as class of named entity, position, and string length, which can be used for further downstream natural language processing. For example, annotations 406 can be in a form such as “NE type X found in input text from position Y to Z” where X is a named entity type identifier and Y and Z are digits or indicators representing position.

Optionally, finite-state recognizer 402 can output annotated text 406 comprising both natural language text and annotations. Also, optionally, recognizer 402 output can be used to build an index into the text 404 or metadata associated with text 404. Subsequent applications can use annotations, index, annotated text and/or metadata 406 to perform more advanced natural language processing or searching of text 404 than with simple tokens/words alone. It is further noted that recognizer 402 can process text in segmented languages such as English or French, which have boundaries or spaces between words or unsegmented languages such as Chinese or Korean where boundaries between words can be ambiguous.

FIGS. 5A and 5B illustrate named entity recognition or identification systems 500 and 550. It is noted that a complete rule (regular expression or grammar) includes both a pattern and an action. Both Flex and Yacc compile patterns into their own internal finite-state representations as discussed with respect to FIGS. 3A and 3B. During run-time, if a match is made, its corresponding action code is run.

FIG. 5A illustrates Flex-generated (or equivalent) lexical analyzer 502 similar to finite-state lexical analyzer 306 in FIG. 3A. Lexical analyzer 502 processes text 404 to generate annotations 506 similar to annotations 406 in FIG. 4. Flex-generated lexical analyzer 502 implements rule actions 504 for matches between patterns in text 404 and specific regular expression and/or grammar rules. In most embodiments, lexical analyzer 502 is generated or constructed by well-known lexical analyzer generator commonly known as “Flex” or Fast Lexical Analyzer Generator. Flex is an implementation of the well-known “Lex” program. Although well known, detailed information pertaining to Flex is available at the following web address: www.gnu.org.

Named entity recognition system 500 is particularly adept at recognizing named entities that have a predictable or regular format such as email addresses or date and time expressions. In most embodiments, named entity recognition system 500 implements regular expression rules similar to regular expression rules 304 illustrated in FIG. 3A. In some embodiments, lexical analyzer 502 identifies named entities in at least one of the following categories or classes: digits, date and time expressions, email addresses, URLs, and web addresses. Such named entities generally occur in a finite set of patterns and have a relatively uncomplicated pattern or format in text 404. For example, a date, such as “Jul. 4, 2004” can be generally found in text 404 in the following patterns or formats: “Jul. 4, 2004”, “Jul. 4, 2004”, “Jul. 4, 2004”, etc. Also, email addresses, each generally consists of an entity identifier (person, department, etc) followed by the symbol “@”, then a provider identifier, a dot or “.” and ends with a suffix generally associated with an organization, or geographical region such as “com”, “org”, “edu”, “nl”, “gov”, etc. For example, a regular expression rule for an email address might be expressed as follows: {A-Z}+@{A-Z}+.{com|org|edu|nl|gov . . . } where {A-Z}+ is a string of any letters from A-Z.

Lexical analyzer 404 generates annotations 506 that can be output to the application layer, document index, and/or for further types of processing as indicated at 508. It is important to note that named entity recognition system 400 can be integrated in natural language processing system 200 illustrated in FIG. 2 and/or the Linguistic Services Platform mentioned above.

FIG. 5B illustrates named entity recognition system 500 comprising Yacc-generated (or equivalent) parser 552 and lexicon 558. Yacc-generated parser 552 is generally similar to finite-state parser 356 in FIG. 3B. Parser 552 receives and/or processes natural language text 404 by matching text patterns with grammar rules similar to grammar rules 354 in FIG. 3B. Upon finding a match, parser 552 implements rule actions 554 to generates named entity annotations 556. Alternatively, parser 552 can generate annotated text to be used to build an index into text 404, or metadata associated with text 404.

Parser 552 can be generated by the well-known parser generator known as “Yacc” or “Yet Another Compiler-Compiler” from AT&T Bell Laboratories, Murray Hill, N.J. In other embodiments, parser 505 can be generated by the well-known parser generator “Bison,” for which detailed information is available at the following web address: www.gnu.org.

In some embodiments, parser 552 applies grammar rules 354 illustrated in FIG. 3B to generate hypotheses or possible named entities, which are then further processed (not shown) to select and/or identify named entities based on a statistical language or probability model. For example, parser 552 can apply a set of grammar rules 354 associated with the person name class so that the natural language text phrase, “Mr. John Smith” be processed into hypotheses such as “John”, “Smith”, “Mr. John”, “John Smith” and “Mr. John Smith”. Further processing can be used to identify “Mr. John Smith” as the most probable named entity in the text.

Parser 552 can be coupled to lexicon 558 comprising person names for look-up. For example, parser 552 can look-up titles in an existing lexicon to identify text such as “Mr.”, “Mrs.”, or “Dr.” After a title is identified, parser 552 can lookup in an existing lexicon comprising first names, and then again, in a lexicon comprising surnames. Alternatively, parser 552 implements a person name grammar rule, which checks the word following a title and first name for capitalization. If the following word is capitalized e.g. “Smith” in the example “Mr. John Smith”, the three-word string is annotated as a person name.

In another embodiment, parser 552 is coupled to lexicon 558 for more extensive look-up. This embodiment is especially applicable in situations where natural language text 404 comprises a single case (all capital or all small case letter). When a single case of text is used, it is more difficult to write character rules to specify named entities. Lexicon 558 can comprise significant named entity information, such as an extensive list of person surnames, to perform named entity look-up regardless of the case of text.

Alternatively, name entity recognition system 550 can identify named entities 556 for further processing to determine classes for which the generated named entities 556 belong. For example, the phrase “St. Paul” can be initially identified by system 550 for later determination of whether “St. Paul” is a person name or a location name.

Annotations 556 can be output to the application layer, document index, or further processing as described with respect to FIG. 2 and/or the Linguistic Services Platform mentioned above.

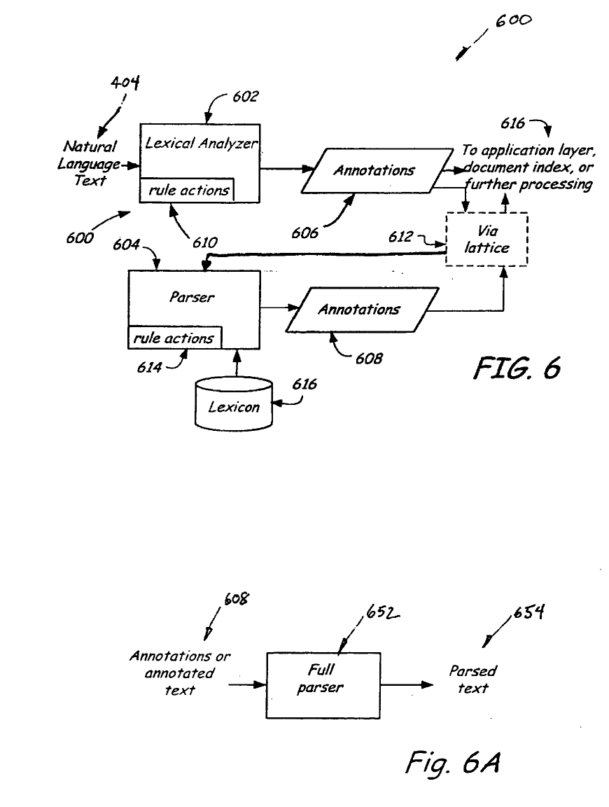

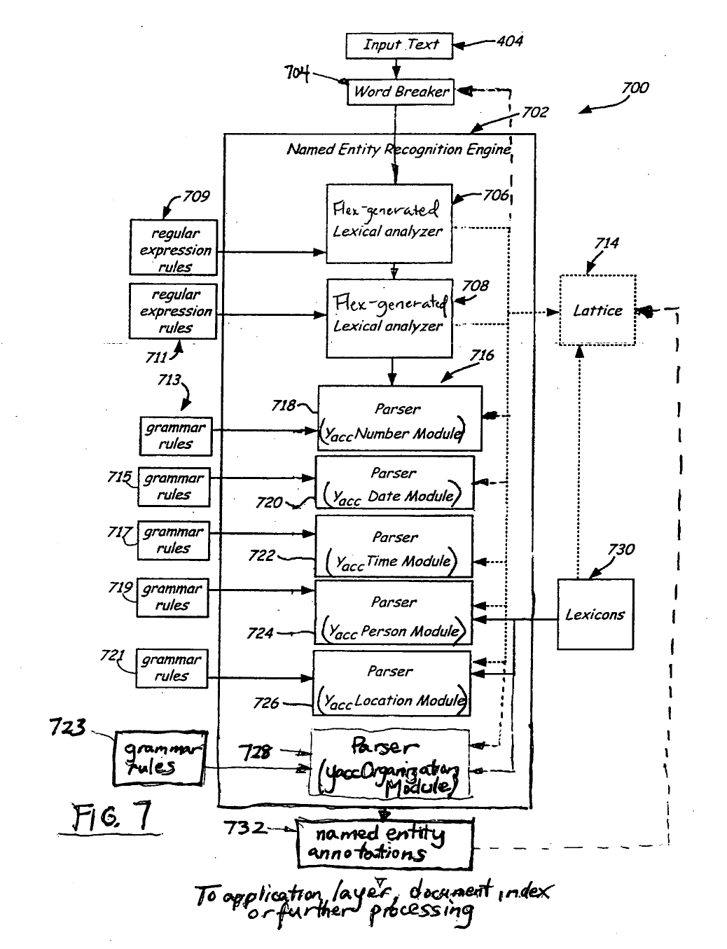

FIG. 6 illustrates named entity recognition system or engine 600, which comprises both lexical analyzer 602 in combination with downstream parser 604 that generate named entity annotations 606, 608 or, alternatively, annotated text 606, 608. In most embodiments, lexical analyzer 602 and parser 604 are generated from Flex and Yacc, respectively, as described above. Lexical analyzer 602 is dedicated to rules, such as regular expression rules 304 illustrated in FIG. 3A and described above. Lexical analyzer applies or implements rule actions 610 (associated with rules 304) upon appropriate pattern match to generate annotations 606. Annotations 606 can, optionally, be output to lattice or platform 612 for further processing by parser 604 or to an application layer, index, or further processing as indicated at 616.

Parser 604 is dedicated to rules, such as grammar rules 354 (illustrated in FIG. 3B) to identify particular sequences of annotations or token types. Parser 604 receives annotations 606 from lexical analyzer 602 or lattice 612 and applies or implements rule actions 614 (associated with rules 354) upon appropriate pattern match to generate or identify additional annotations 608. Annotations 608, (like annotations 606) can be output to the application layer, document index, or for further processing as indicated at 616.

In some embodiments, parser 604 is able to access lexicon 616, such as a lexicon of first names to identify and classify tokens into types. Briefly, Yacc uses a grammar to describe legal token sequences, and can also carry out actions when part or all of a sequence is found. Both Flex and Yacc compile their character and/or token rules into computer program code for highly efficient finite-state recognizers 602, 604 dedicated to those rules; and these programs are then compiled into executable programs.

For example, suppose the sequence “Mr. John Smith” is received in natural language text 404. Lexical analyzer 602 can implement a person name rule where titles or constituent character strings such as “Mr.”, “Mrs.”, “Ms.”, “Dr.”, etc. are annotated as <titles> in annotations 606. In the present case, “Mr.” would be recognized and annotated as a title annotation or token <Mr.>. Parser 604 then receives the token <Mr.> and further applies grammar rules to check words following <Mr.>. For example, parser 604 can implement grammar rules that, for example, specify that parser 604 looks up “John” in a first name lexicon 616 to determine whether “John” is a first name. The grammar rules can then specify that parser 604 determine whether “Smith” is capitalized. Assuming proper match of the text pattern to the grammar rules, parser 604 determines that “Mr. John Smith” is a person's name and annotates the text sequence as such to generate annotations 608.

FIG. 6A illustrates an embodiment where annotations or annotated text 608 is output for further processing. Generally, full parsers are used to parse text, especially full sentences into grammatical elements, such as subject, verb, object, etc. Full parsers can be useful in applications such as text translation (especially when coupled to a bilingual dictionary and grammar module) but are relatively slow. In contrast, Flex-generated lexical analyzers and Yacc-generated parsers (and their respective equivalents) process text in a limited, simple left-to-right scan, and consequently, are very fast. Thus, full parsing commonly used in various natural language processing applications is generally much slower than scanning and/or parsing with machine compiler tools.

FIG. 6A illustrates full parser 652 receiving annotated text 608 that can be generated by the scheme illustrated in FIG. 6. Named entities are annotated or tokenized in annotated text 608. Full parser 652 parses sentences in annotated text 608 to generate fully parsed text 654 where grammatical elements such as subject, verbs, and other parts of speech are identified. Annotated text 608 can speed up a full parsing process because full parser 652 can consider a named entity token as one word rather than a string of words, and avoid expensive analysis of every individual word, though typically at the expense of some accuracy. For example, full parser 620 can consider “Mr. John Smith” a single word or entity.

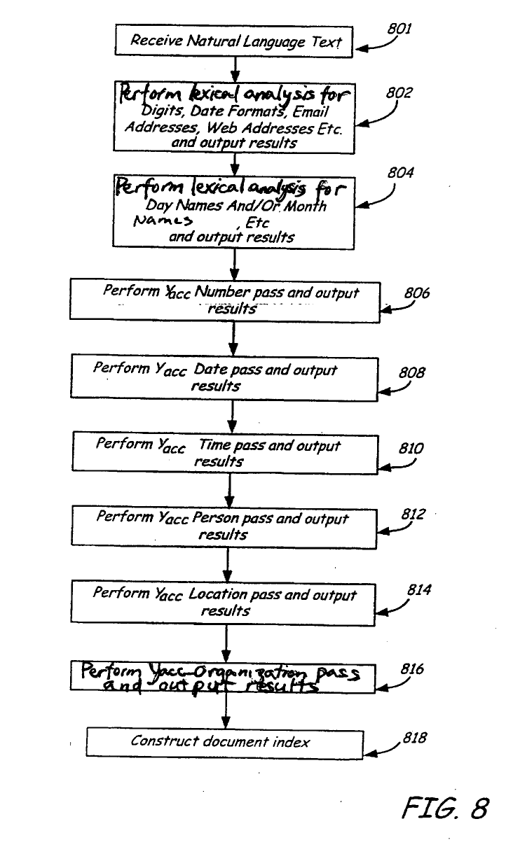

FIGS. 7-8 illustrate system 700, which comprises various modules and steps, especially for identifying named entities in accordance with the present inventions described above. It is important to note that the methods, steps, modules, and sub-modules illustrated can be combined, divided, re-combined, added to, or deleted as desired by those skilled in the art without departing from the scope of the present inventions.

System 700 includes named entity recognition engine 702 comprising cascading lexical analyzers 706, 708 and parsers 718, 720, 722, 724, 726. For purposes of understanding, it is noted that the recognition process described herein is broken up into a sequence or cascade of separate recognizers comprising both lexical analyzer (scanner) and parser modules, or steps, each specialized for a particular named entity class or category. Such a configuration, however, should not be considered limiting. It is noted that extracting various classes of named entities separately generally avoids conflicts between rules for different classes, which could otherwise overlap. Also, multiple analyses of ambiguous input text can be performed, which is not possible with a single recognizer. For example, with multiple passes “Julian Hill” can be recognized as a possible named entity by both person name and location name rules.

Further, the Flex analysis and the Yacc analysis of an input text can be split into multiple passes, each with its own set of rules, especially to avoid conflicts between overlapping or ambiguous rules, and allow recognition of natural language constructions which cannot be described in a single set of rules. Flex has a built-in limitation to find only the longest possible match. Therefore, separate passes with different rules are needed to allow any overlapping or embedded named entities to be matched. Similarly, Yacc has a built-in limitation to ignore all but the first of multiple candidate rules. If the first rule subsequently fails to match, no others will be considered, and thus, no match will be found. For named entity recognition, where multiple candidate rules are required, they can be split into separate grammars and applied in separate passes.

Importantly, both Flex and Yacc can be integrated into the Linguistic Services Platform described above, as optional features which can be applied to input text to produce a linguistically-enriched output, annotating sequences which match the named entity rules for certain classes or types. Linguistic Services Platform uses lattice 714, or table, to represent information about input text. Text 404 is passed through at least one Flex-generated or equivalent lexical analyzer and any matches cause actions to insert new information into the lattice. Then the lattice contents are passed through a Yacc-generated or equivalent parser and again any matches cause actions to insert new information into the lattice.

In some embodiments, NE recognition engine 212, 600, 702 (illustrated in FIGS. 2, 6, and 7, respectively) takes advantage of lexicons 206, 616, 730 by using them to classify words or tokens into types of named entities or constituents for use in general linguistic rules, e.g. person first names and city names, so that NE recognition engine 212, 600, 702 does not need to have a fixed set built into its rules, and lexicons 206, 616, 730 do not need to include full names which can be recognized by rules.

Additionally, the named entity recognition engine or component 212, 600, 702 can take advantage of the Linguistic Services Platform's lattice scoring mechanism, or language model, to rank multiple candidates of named entities and select the best or most probable one from a group of overlapping and/or conflicting entries.

It is noted that named entity recognition in accordance with the present inventions is high performance due to its use of Flex and/or Yacc (or their respective equivalents) to build fast finite-state recognizers. Integrating Flex and Yacc into the Linguistic Services Platform maintains these high performance advantages by adapting input/output from the lattice to Flex's and Yacc's requirements or needs, and also by minimizing any relatively expensive operations, such as lexicon look-up, to just the situations where the required information cannot be obtained any other way (e.g. classifying tokens by matching them in Flex, where possible and practical, rather than searching the whole lexicon).

Referring back to FIGS. 7-8, at step 801, named entity recognition engine 702 is initialized to receive input natural language text 404 such as from any of the input or storage devices described above. Natural language text 404 can be obtained from the Internet, such as from text in various web pages, or other publications. Text 404 can also be obtained from various engines such as speech-to-text or handwriting-to-text engines.

Named entity recognition engine 702 can be coupled to word breaker 704, which identifies individual words in input natural language text 404. In the embodiment illustrated in FIG. 7, word breaker output is provided to named entity recognition engine 702 via lattice 714. Alternatively, however, word breaker output can be provided directly to engine 702. For text in segmented languages such as English, word breaker 704 can distinguish words from other features such as whitespace and punctuation. For text in unsegmented languages, such as Chinese or Japanese, word breaker 704 can comprise or be coupled to a parser (not shown) that resolves segmentation ambiguities to segment the unsegmented language into words.

At step 802, lexical analyzer or recognizer 706 dedicated to regular expression rules 709 performs recognition of character-based named entities or constituent character strings. In some embodiments, lexical analyzer 706 identifies named entities in the following classes: digits, date expressions, email addresses, web addresses, currencies, and similar regular expressions. In other words, rules 709 can comprise email address rules specifying any sequence of characters from a to z, followed by the symbol “@”, then by any sequence of characters from a to z, followed by a “.”, and ending with a suffix such as “com”, “org”, “edu”, etc. as described above.

Lexical analyzer 706 generates annotations or tokens that can be provided to lexical analyzer 708 directly or via lattice 714 as illustrated. Further, lexical analyzer 706 can optionally provide output directly to the application layer above as described with respect to reference 616 in FIG. 6. For example, text annotated with email or web addresses can be useful for various applications or where computing capacity for further recognizing is limited.

At step 804, lexical analyzer 708 receives annotations or annotated text from lexical analyzer 706 and performs further named entity and/or constituent character string recognition in accordance with regular expression rules 711 as described above. In some embodiments, rules 711 relate to the following classes of named entities: day names, month names, etc. Lexical analyzer 708 outputs annotations or annotated or tokenized text directly to parser 718, or optionally, via lattice 714 as illustrated.

At step 806, parser 718 receives annotations from both lexical analyzer 706 and lexical analyzer 708 for further named entity recognition. Parser 718 is generated by Yacc (or its equivalent) from grammar rules 713. In some embodiments, rules 713 specify named entities in the following classes: number expressions. It is noted that number named entities recognized by parser 718 are generally numbers spelled out in text such as “one hundred and thirty-three”. Parser 718 generates annotations that can be communicated to lattice 714 as illustrated or directly to parser 720.

At step 808, parser 720 receives annotations from lexical analyzer 706, lexical analyzer 708, and parser 718 for further named entity recognition. Parser 720 is generated by Yacc (or its equivalent) from grammar rules 715. In some embodiments, rules 715 specify named entities in the following classes: date expressions. Parser 720 communicates results to lattice 714 or directly to parser 722 for further similar downstream processing.

At step 810, parser 722 receives annotations from the previous modules and performs further recognition or identification of named entities. Parser 722 is generated by Yacc (or its equivalent) from grammar rules 717. As illustrated in FIG. 7, named entity recognizer 722 can be coupled to lattice 714 to communicate results, such as annotated lattice tokens.

At step 812, named entity recognition engine 702 performs recognition of person names using parser 724, generated by Yacc (or its equivalent) from grammar rules 719. Output of parser 724 can be in the form of annotated lattice tokens to lattice 714 for further downstream processing. The Appendix below describes an embodiment of grammar rules 719 in Yacc format. At step 814, Yacc-generated (or equivalent) parser or module 726 performs named entity recognition of locations names and provides annotations or lattice tokens, which can be provided to lattice 714 for later processing.

At step 816, named entity recognition engine 702 has identified named entities 728 in natural language text 404 (including both character-based and token-based named entities) in accordance with regular expression rules 709, 711 and grammar rules 713, 715, 717, 719, 721. Named entity annotations generated by engine 702 can be provided to lattice 714, or alternatively, to an application layer, document index, or further processing. It is important to note that the embodiments illustrated in FIGS. 7 and 8 are not intended to be limiting. Rather, even though the illustrated regular expression and grammar rules have been divided into specific classes of named entities and constituent character strings, other combinations of regular expression rules and/or grammar rules are possible. Also, as appreciated by those skilled in the art, other classes of named entities (such as measurements, phone numbers, product names, etc.) can be implemented with other corresponding modules.

It is further noted that Yacc-generated (or equivalent) parsers 718, 720, 722, 724, 726 can be adapted to look up token types, for example, in various lexicons 730 (e.g. a list of person first names) in place of or in addition to types from annotated lattice tokens, such as those provided by Flex-generated lexical analyzers or parsers 706, 708 or any upstream recognizer. Lexicon access, however, can be minimized by only looking up capitalized tokens which were not matched by the lexical analyzers. If the input text is known to be a single case, capitalization tests can be skipped and lexicon lookup increases significantly.

In other embodiments, annotated lattice tokens constructed from named entities identified by the above described Flex-based and/or Yacc-based named entity recognizers can be used for creating a web index. Due to the speed of system 700, it is contemplated that Internet web pages numbering in several billion pages of text can be processed or indexed by system 700 within several days of computing time, many times faster than would be possible with typical linguistic parsing methods.

### Results

In actual tests performed for named entity recognition in accordance with the present or similar system as illustrated in FIG. 7, performance of the prototype implementation of the system reached 75,000 words/second with an accuracy of 90% (combined recall and precision) on the training data from the MUC-7 (7^{th} Message Understanding Conference) named entity system evaluation.

Although the present invention has been described with reference to particular embodiments, workers skilled in the art will recognize that changes may be made in form and detail without departing from the spirit and scope of the invention.

APPENDIX

```
%token FNME NME INITL VON ABRV INITCAP TITL SUFFIX
HYPHEN QUOTE COMMA SKIP
%% /* start of grammar */
top: /* empty */
  | person { pEngine->yynewtoken($1); }
  | error { yyerrok; yyclearin; } top
  ;
person:
  name { $$ = $1; }
  | title name { $$ = $1+$2; }
  | title lastname { $$ = $1+$2; }
  | title INITCAP { $$ = $1+1; }
  | name suffix { $$ = $1+$2; }
  | title name suffix { $$ = $1+$2+$3; }
  ;
name:
  forename { $$ = $1; }
  | forename lastname { $$ = $1+$2; }
  | initial lastname { $$ = $1+$2; }
  | forename initial lastname { $$ = $1+$2+$3; }
  | von lastname { $$ = $1+$2; }
  | von INITCAP { $$ = $1+1; }
  | forename von lastname { $$ = $1+$2+$3; }
  | forename von INITCAP { $$ = $1+$2+1; }
  | forename nickname lastname { $$ = $1+$2+$3; }
  | NME lastname { $$ = 1+$2; } /* Khaxflg Baker */
  | forename INITCAP { $$ = $1+1; } /* George Foreman */
  ;
forename:
  FNME { $$ = 1; } /* George */
  | FNME HYPHEN initcap { $$ = 2+$3; } /* George-Khaxflg */
  | initcap HYPHEN FNME { $$ = $1+2; } /* Khaxflg-George */
  | forename FNME { $$ = $1+1; } /* David George */
  ;
lastname:
  NME { $$ = 1; } /* Baker */
  | TITL { $$ = 1; } /* Pope */
  | NME HYPHEN initcap { $$ = 2+$3; } /* Baker-Flibbertagoola */
  | initcap HYPHEN NME { $$ = $1+2; } /* Flibbertagoola-Baker */
  | ABRV lastname { $$ = 1+$2; } /* St. Hubbins */
  | INITL initcap { $$ = 1+$2; } /* Q Flibbertagoola */
  | lastname initcap { $$ = $1+$2; } /* Jingleheimer Schmidt */
  ;
initial:
  INITL { $$ = 1; }
  | initial INITL { $$ = $1+1; }
  ;
von:
  VON { $$ = 1; }
  | von VON { $$ = $1+1; }
  ;
nickname:
  QUOTE initcap QUOTE { $$ = $2+2; }
  ;
title:
  TITL { $$ = 1; }
  | title TITL { $$ = $1+1; }
  | INITCAP title { $$ = 1+$2; }
  ;
suffix:
  SUFFIX { $$ = 1; }
  | COMMA SUFFIX { $$ = 2; }
  | suffix SUFFIX { $$ = $1+1; }
  | suffix COMMA SUFFIX { $$ = $1+2; }
  ;
initcap:
  NME { $$ = 1; }
  | FNME { $$ = 1; }
  | INITCAP { $$ = 1; }
  ;
```

What is claimed is:

1. A computer readable medium having stored thereon computer readable instructions which, when read by the computer cause the computer to perform steps of:
receiving a natural language input through an application programming interface (API);
providing the natural language input to one or more natural language processing (NLP) components, including a named entity recognizer to perform named entity analysis operations on the natural language input using a compiler tool designed to parse computer programs, the named entity analysis operations selected from a plurality of different possible NLP analysis operations selectable through the API; and
returning analysis results from the named entity operations through the API.

2. The computer readable medium of claim 1, and further comprising selecting types of named entities through the API from a plurality of types of named entities.

3. The computer readable medium of claim 2, wherein the named entity recognizer identifies the selected types of named entities in the natural language input and returns analysis results for the selected types.

4. The computer readable medium of claim 1, wherein the named entity recognizer is generated from at least one of a lexical analyzer generator and a parser generator.

5. The computer readable medium of claim 4, wherein the lexical analyzer generator comprises one of Fast Lexical Analyzer generator (Flex) or Lexical Analyzer generator (Lex).

6. The computer readable medium of claim 5, wherein the parser generator comprises one of Yet Another Compiler-Compiler (Yacc) or Bison.

7. The computer readable medium of claim 1, wherein returning analysis results comprises returning named entity annotations or named entity annotated text through the API.

8. The computer readable medium of claim 7, wherein the named entity annotations each comprise at least one named entity class identifier.

9. The computer readable medium of claim 8, wherein the named entity annotations each further comprise a position indicator.

10. The computer readable medium of claim 1, and further comprising accessing a language model to rank named entity candidates, the language model comprising probability information used to select a named entity from a plurality of possible named entities.

11. The computer readable medium of claim 1, and further comprising accessing at least one lexicon of named entities or constituents to be used in subsequent named entity analysis operations.

12. A method of performing natural language processing comprising the steps of:
receiving natural language text through an API;
selecting named entity analysis operations from a plurality of available natural language processing operations through the API; and
using a recognizer generated by a compiler tool to identify named entities in the natural language text.

13. The method of claim 12, and further comprising returning the identified named entities through the API.

14. The method of claim 13, wherein returning the identified named entities comprises returning named entity annotations or named entity annotated text to a requesting application through the API.

15. The method of claim 12, and further comprising selecting classes of named entities from among a plurality of classes of named entities through the API.

16. The method of claim 12, wherein using a recognizer comprises using a recognizer generated by at least one of a lexical analyzer generator and a parser generator.

17. The method of claim 16, wherein using a recognizer comprises using a recognizer generated by Flex or Lex.

18. The method of claim 16, wherein using a recognizer comprises using a recognizer generated by Yacc or Bison.

19. A method of performing named entity analysis operations comprising the steps of:
receiving natural language text through an API; and
identifying classes of named entities in the natural language text using the steps of:
implementing regular expression rules associated with classes of named entities using at least one recognizer generated by Flex; and
implementing token rules associated with classes of named entities using at least one recognizer generated by Yacc.

20. The method of claim 19, wherein identifying named entities further comprises accessing a language model to rank possible named entities based on probability.

21. The method of claim 19, wherein identifying named entities comprises accessing at least one lexicon of named entities and named entity constituents.
